(19) United States
(12) Patent Application Publication
(10) Pub. No.: US 2023/0393525 A1
(43) Pub. Date: Dec. 7, 2023

(54) SYSTEM AND METHOD FOR COMPUTER-GENERATED HOLOGRAPHY SYNTHESIS

(71) Applicant: InterDigital CE Patent Holdings, SAS, Paris (FR)

(72) Inventors: Vincent Brac De La Perriere, RENNES (FR); Didier Doyen, Cesson-Sévigné (FR); Valter Drazic, Betton (FR); Arno Schubert, Val d'Izé (FR); Benoit Vandame, Betton (FR)

(73) Assignee: InterDigital CE Patent Holdings, SAS, Paris (FR)

(21) Appl. No.: 18/032,122

(22) PCT Filed: Oct. 19, 2021
(86) PCT No.: PCT/EP2021/078896

§ 371 Date: Apr. 14, 2023

(30) Foreign Application Priority Data
Oct. 28, 2020 (EP) 20306294.8

(51) Int. Cl. G03H 1/08

(52) U.S. Cl. CPC G03H 1/0808; G03H 2210/30; G03H 2001/2281

(57) ABSTRACT

Processing image information associated with a 3D scene can involve obtaining image data associated with at least one layer of the 3D scene; determining at least one phase increment distribution associated with the at least one layer for modifying at the at least one layer an image size associated with the scene; and determining a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.

### TECHNICAL FIELD

The present disclosure involves Digital Holography (DH) and Computer-Generated Holograms (CGH).

### BACKGROUND

The principle of Digital Holography (DH) is to reconstruct the exact same light wave front emitted by a 3-dimensional object. This wave front carries all the information on parallax and distance. Both types of information are lost by 2-dimensional conventional imaging systems (digital cameras, 2 dimensional images . . . ), and only parallax can be retrieved using recent multi-view light-field displays. The impossibility of such displays to render both parallax and depth cues leads to convergence-accommodation conflict, which can cause eye strain, headache, nausea and lack of realism.

Holography is historically based on the recording of the interferences created by a reference beam, coming from a coherent light source, and an object beam, formed by the reflection of the reference beam on the subject. The interference pattern was recorded in photosensitive material, and locally (microscopically) looks like a diffraction grating, with a grating pitch of the order of the wavelength used for the recording. Once this interference pattern has been recorded, its illumination by the original reference wave re-creates the object beam, and the original wave front of the 3D object.

The original concept of holography evolved into the modern concept of Digital Holography. The requirements of high stability and photosensitive material made holography impractical for the display of dynamic 3D content. With the emergence of liquid crystal displays, the possibility of modulating the phase of an incoming wave front, and thus of shaping it at will, made it possible to recreate interference patterns on dynamic devices. The hologram can this time be computed and referred to as a Computer-Generated Hologram (CGH). The synthesis of CGH requires the computation of the interference pattern that was previously recorded on photosensitive material, which can be done through various methods using Fourier optics. The object beam (i.e., the 3D image) can be obtained, for example, by illuminating a liquid crystal on silicon spatial light modulator (LCOS SLM) display bearing the CGH with the reference beam.

### SUMMARY

In general, at least one example of an embodiment can involve a method comprising: obtaining image data associated with at least one layer of a 3D scene; determining at least one phase increment distribution associated with the at least one layer for modifying at the at least one layer an image size associated with the scene; and determining a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.

In general, at least one other example of an embodiment can involve apparatus comprising: at least one processor configured to obtain image data associated with at least one layer of a 3D scene; determine at least one phase increment distribution associated with the at least one layer for modifying the at least one layer an image size associated with the scene; and determine a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.

In general, at least one other example of an embodiment can involve a method comprising: obtaining image data associated with a plurality of layers of a 3D scene including a first layer at a first distance from a result layer and a second layer at a second distance from the result layer, wherein the first distance is greater than the second distance; determining a plurality of phase increment distributions, wherein each of the plurality of phase increment distributions is associated with a respective one of the plurality of layers for modifying, at the respective one of the plurality of layers, an image size associated with the scene; and determining an image wave front at each of the plurality of layers based on a propagation of an image wave front from the first layer through the second layer to the result layer to form a propagated image wave front at the result layer representing a hologram of the scene, wherein the propagation includes, for each of the first layer and the second layer, applying a respective one of the plurality of phase increment distributions associated with a layer to the image wave front at the layer.

In general, at least one other example of an embodiment can involve apparatus comprising: at least one processor configured to obtain image data associated with a plurality of layers of a 3D scene including a first layer at a first distance from a result layer and a second layer at a second distance from the result layer, wherein the first distance is greater than the second distance; determine a plurality of phase increment distributions, wherein each of the plurality of phase increment distributions is associated with a respective one of the plurality of layers to modify at the respective one of the plurality of layers an image size associated with the scene; and determine an image wave front at each of the plurality of layers based on a propagation of an image wave front from the first layer through the second layer to the result layer to form a propagated image wave front representing a hologram at the result layer, wherein the propagation includes, for each of the first layer and the second layer, applying a respective one of the plurality of phase increment distributions associated with a layer to the image wave front at the layer.

In general, at least one other example of an embodiment can involve a method comprising: obtaining image data associated with a plurality of layers of a 3D scene; determining a plurality of phase increment distributions, each associated with a respective one of the plurality of layers, for modifying at the respective one of the plurality of layers an image size associated with the scene; determining, for each of the plurality of layers, a propagation to the result layer of an image wave front associated with the image data of the layer based on applying a respective one of the plurality of phase increment distributions associated with a layer to the image data of the layer; and combining the propagation of each of the plurality of image wave fronts associated with respective ones of the plurality of layers to form a propagated image wave front at the result layer representing a hologram of the scene.

In general, at least one other example of an embodiment can involve apparatus comprising: at least one processor configured to obtain image data associated with a plurality of layers of a 3D scene; determine a plurality of phase increment distributions, each associated with a respective one of the plurality of layers, for modifying at the respective one of the plurality of layers an image size associated with the scene; determine, for each of the plurality of layers, a propagation to the result layer of an image wave front associated with the image data of the layer based on applying a respective one of the plurality of phase increment distributions associated with a layer to the image data of the layer; and combine the propagation of each of the plurality of image wave fronts associated with respective ones of the plurality of layers to form a propagated image wave front at the result layer representing a hologram of the scene.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF DESCRIPTION OF THE DRAWINGS

The present disclosure may be better understood by considering the detailed description below in conjunction with the accompanying figures, in which:

FIG. 1 illustrates an example of orthographic projections of an object;

FIG. 2 illustrates an example of perspective vs. orthographic projections;

FIG. 3 illustrates an example of object space representation of multi-plane images (MPIs) at fixed pixel size (upper illustration in FIG. 3) versus object space representation of MPIs in adapted pixel size (lower illustration in FIG. 3) depending on depth;

FIG. 4 illustrates an example of a representation of phase levels of a rectangular zone plate;

FIG. 5 illustrates an example of an embodiment involving association of simulated Fresnel zone plates (FZPs) on the propagation of a wave front;

FIGS. 6A and 6B illustrates an example of an embodiment involving a magnifying feature, e.g., using FZPs, with two layers;

FIG. 7 illustrates, in flow diagram form, an example of an embodiment;

FIG. 8 illustrates, in flow diagram form, an example of another embodiment;

FIG. 9 provides pseudo-code illustrating an example of an embodiment;

FIG. 10 illustrates, in flow diagram form, an example of another embodiment; and

FIG. 11 illustrates, in block diagram form, an example of an embodiment of a system suitable for implementing one or more aspects of the present disclosure.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

CGH and DH solve the convergence-accommodation conflict by recreating the exact same wave front as emitted by the initial 3D scene. For that, a hologram needs to be computed, which is done by computing the wave front emitted by the scene in the plane of our CGH, and associate it with a reference light, which will be used for playback (illumination of the hologram). In modern optics, wave front propagation is modeled through light diffraction, e.g., Fourier optics, and each point of the wave front can be considered as a secondary source diffracting light.

One major aspect of CGH synthesis is thus evaluating the light field emitted by a 3D object or scene toward a (hologram) plane. CGH can be synthesized from any form of 3D content, using different approaches. Two principal methods are used, based on point clouds and layered 3D scenes.

Various approaches to synthesizing CGH are possible. For example, one approach is based on Point Clouds. Another approach is based on Layered 3D scenes.

The point cloud approach involves computing the contribution of each point of a 3D scene to the illumination of each pixel of the hologram. Using this model, each point can be either considered as a perfect spherical emitter or described using Phong's model. The light field in the hologram plane is then equal to the summation of all points contributions, for each pixel. The complexity of this approach is proportional to the product of the number of points in the scene by the number of pixels, it thus implies an important computational load, and requires the computation of occlusions separately. The summation of each point and each pixel is described by the equations of Rayleigh-Sommerfeld or Huygens-Fresnel.

A three-dimensional scene can as well be described as a superposition of layers, considered as slices of the 3D scene. From this paradigm, the scene is described as a superposition of layers, to each of which is associated a depth in the scene. This description of a 3D scene is very well adapted to Fourier Transform models of diffraction. This is especially the case for the model of angular spectrum. The layer approach to compute CGHs has the advantage of low complexity and high computation speed due to the use of Fast Fourier Transform algorithms (FFT) embedded inside a Propagation Transform (PT), enabling the processing of a single layer at high speed. Some techniques were also designed to take care of occlusions, through the implementation of masks in active pixels, or ping-pong algorithms. One approach is to simulate propagation of light through the scene starting at the furthest layer, e.g., at a background layer. The light propagation is then computed from the furthest layer to the hologram plane, by layer-to-layer propagation transform. In detail, the light emitted by layer N received by the next layer plane N+1 is computed, and the contribution of this layer N+1 (meaning the light emitted by N+1) is added to the result. The light emitted by the layer N+1 is multiplied by the layer mask. The light emitted by layer N+1 is equal to the sum of both contributions.

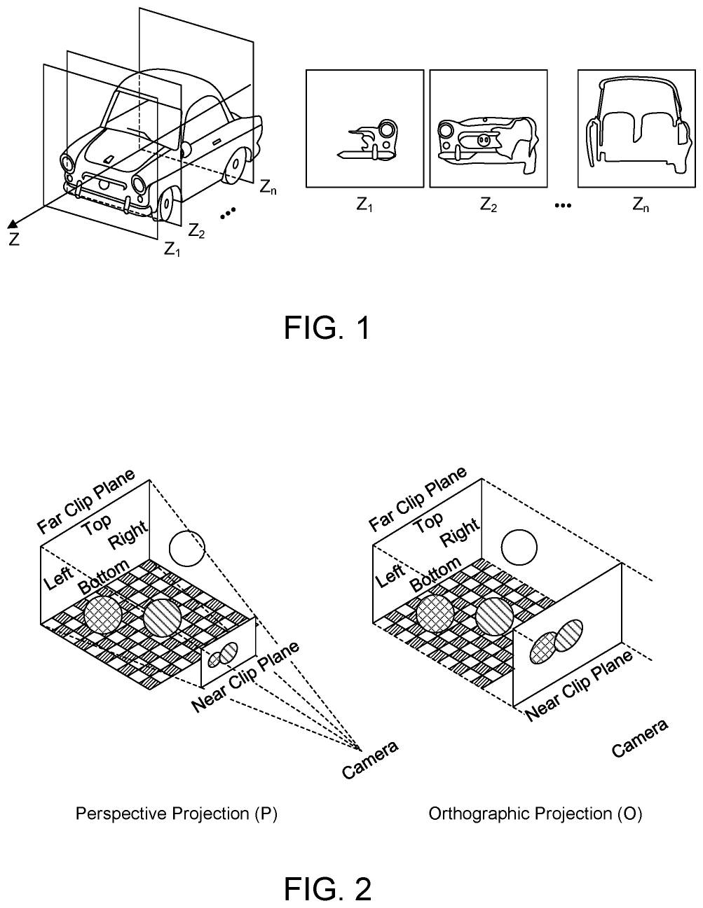

The layer-based method for the synthesis of CGHs is a fast-computational method but cannot be applied to large viewing angle objects or scenes. As the FFT algorithm can only be computed between matrices of same size, the pixel pitch and number of pixels in each individual slices of the scene (layers) must be equal to the pixel pitch and number of pixels of the displayed hologram. If layers used in the layer-based method are an orthographic projection of the scene (i.e., a 2D slice of the 3D scene), the consequence is that the displayed object or scene must be rather small. An example of orthographic projections of a 3D object are illustrated in FIG. 1. If we take the example of the car in FIG. 1, we see that the size of each layer must be equal to the size of the hologram, and therefore the overall object must be of the same size as well. To put it in different words, the layer-based method is unable to construct a Dynamic Window with a large enough Field of View, given the constraint imposed by the FFT and the orthographic projection. Thus, although a layer-based technique is fast compared to a Point-Cloud technique, displaying large viewing angles of objects or scenes can be problematic with a layer-based approach because of the process and algorithms involved.

In general, at least one example of an embodiment in accordance with the present disclosure can involve using at least one layer of a 3D scene wherein the at least one layer can be an orthographic image or a perspective projection image. In general, at least one example of an embodiment involving at least one image layer, the at least one image layer comprises a plurality of constant resolution perspective view images, e.g., Multi-Plane Images (MPI). In general, at least one example of an embodiment can involve at least one layer of a 3D scene and a phase increment distribution, e.g., Fresnel Zone Plates (FZP), to modify a size of an image associated with a layer. For example, the phase increment distribution can be applied to increase or magnify the image size, e.g., to reconstruct the Field of View (FOV). Thus, at least one embodiment can maintain or reconstruct the FOV of one or more layers of a 3D scene using a corresponding one or more phase increment distributions, thereby enabling applying a layer-based approach to produce CGH. That is, least one example of an embodiment involves using layers which can be seen as a perspective view of the 3D scene, rather than a slice of the scene, given a certain point of view (e.g., a camera).

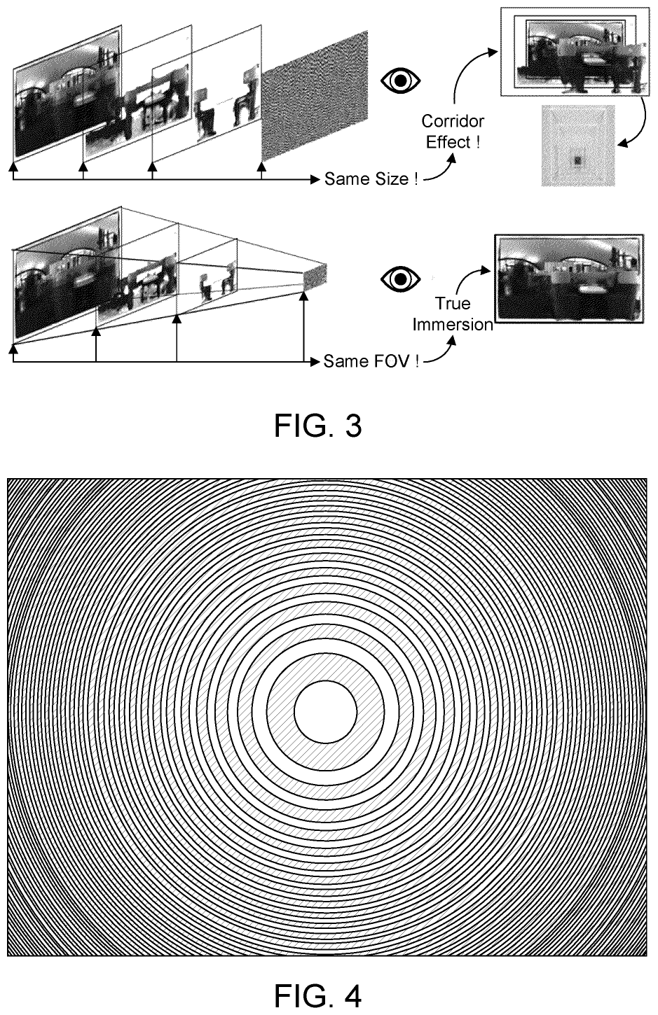

In general, at least one example of an embodiment involves these images having a constant resolution (i.e., number of pixels) along the scene depth. This means that the size of a pixel is proportional to the layer depth in the scene as explained herein. In contrast, orthographic projection is a “simple’ slice of the scene, thus it does not require a point of view (or camera). All layers form a parallelepiped as they all have the same pixel pitch in the object space. However, as explained herein, without careful transformation, MPI layers will form a parallelepiped as well, as they have constant resolution but the pixel size is not constant. An example is illustrated in FIG. 3 and described in more detail herein.

Multi-Plane Images (MPIs) is a particular case of layer content. MPIs involve a layer description of a 3D scene, almost always resulting from a multi-view scene, but could also possibly be obtained from a computer-generated scene. The MPI “format” can typically be considered as a set of fixed resolution (in pixels) images and a set of metadata gathering parameters like the depth of each image and focal length of the synthesis camera, to name but a few. A difference between MPIs and classic slices of a 3D scene is that MPIs are not an orthographic projection (or cross section) of the scene but a perspective projection. With orthographic projection, layers situated in the background will have the same pixel pitch and number of pixels than layers in the foreground, whereas for perspective projection, the pixel pitch of the layers is linearly increasing with depth. A comparison of perspective and orthographic projection is illustrated in FIG. 2.

The representation of MPIs in object space should thus be a truncated pyramid instead of a box when considering orthographic projection, i.e., a box formed from the layers of the sliced scene as illustrated in FIG. 2. However, MPIs have the same pixel size over the set of images and their representation in the object space thus tends to be a box when represented with fixed resolution (in pixel/mm). In conventional computer graphics, making an image of such a scene requires either a projective camera or a transform increasing (or pixel coordinate) in the distance. Despite this projection problem, perspective projection images (like MPIs) are compatible with FFT algorithms (constant number of pixels). Thus, perspective projection images appear to be good candidates for the use of layer-based CGH synthesis method, but if computed as is, will create a 3D scene with a “corridor effect”, e.g., as illustrated in the upper portion of FIG. 3, due to the constant number of pixels of objects of different pixel pitch (background layers being larger than foreground layers).

In general, at least one example of an embodiment involves addressing this projection problem using perspective projection images (like MPIs) that are compatible with FFT algorithms (constant number of pixels) and enabling retrieval of the FOV by the application of a projective correction. In general, at least one example of an embodiment described herein comprises applying phase increment distribution, e.g., Fresnel Zone Plate (FZP) or Zone Plate (ZP), to reconstruct or increase the FOV of layered image information used to create a computer generated hologram. Use of phase increment distribution such as FZP is the diffraction equivalent to the common refractive lens, with similar effects on light wave. The working principle of such an arrangement is to introduce phase delay along a wave propagation to simulate the phase delay introduced by a lens on optical path. By doing so, the light is diffracted to be either focused or defocused, similarly as it would be by a refracting lens. An approach such as ZPs can either modulate the phase or amplitude of incoming light (or optical field). At least one example of an embodiment in accordance with the present disclosure can involve applying a phase change, e.g., changing phase only without changing amplitude. For example, the effect of a FZP on the propagation of light can thus be modelled based on adding a phase component to the travelling wave, which is dependent on the position to the center of the FZP as illustrated in FIG. 4. In general, at least one example of an embodiment can involve obtaining or determining the effect of a phase increment distribution, e.g., a FZP or ZP, on propagation of a wave front. For example, the effect can be computed by applying the propagation transform from the image to the plane of the FZP, multiplying the propagated wave front by the phase distribution of the FZP, and considering the result as an output wave front to be propagated again.

In more detail, a phase shift introduced by a zone plate can be determined by the following equation.

$${φ}_{F Z P} = exp ( - \frac{2 j π}{λ} \frac{( {x}^{2} + {y}^{2} )}{2 {f}_{F Z P}} )$$

where φ_{FZP} is the phase shift of the FZP, x and y are the coordinates of space in the plane of the zone plate, f_{FZP} is the focal length of the zone plate and λ is the wavelength considered.

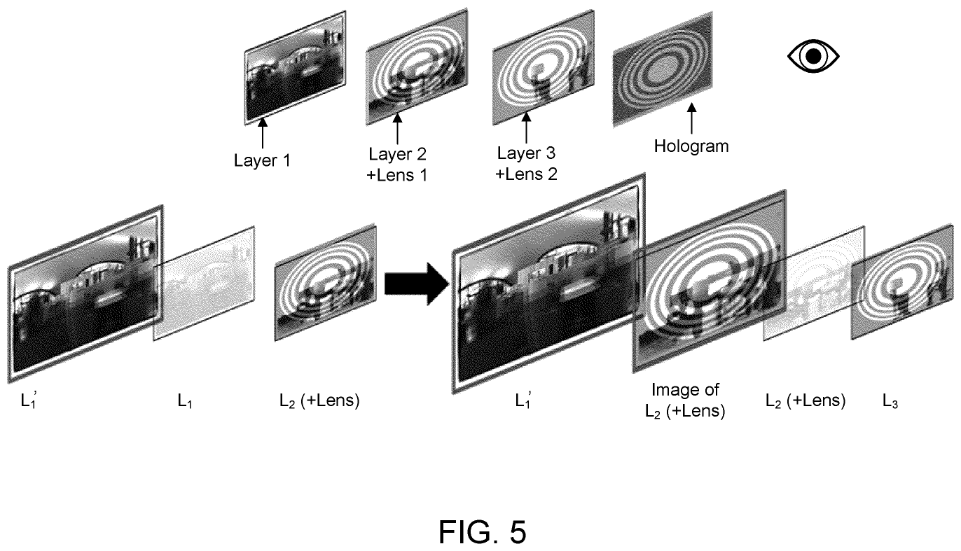

In an example of an embodiment illustrated in FIG. 5, based on use of phase increment distribution such as FZP, the FZP is associated to the layers as magnifiers (labeled “Lens 1” and “Lens 2” in the example of FIG. 5) to optically increase the sizes of the further layers. During the propagation, FZPs simulate the presence of lenses, which effect will be to produce an increased size image. In the example of FIG. 5, the scene is represented by three layers in this case: layer 1 is the furthest and layer 3 is the closest to the hologram plane. More generally, any number of layers and instances of phase increment distribution such as FZP can be used. Adding layers can provide an increasing impression of realism. As an example, the number of layers can be inversely proportional to the distance to the camera (i.e., matching the depth resolution sensitivity of the human eye).

In the example of FIG. 5, a magnifier (e.g., FZP acting as a “lens” or magnifier) is associated to each layer, lying in the plane of the next layer in line except for layer 3 that, in the example of FIG. 5, is considered to be lying in the hologram plane. Each lens will have an impact on the precedent layers, as it will not only affect the wave front of the precedent layer but also of the light received by this layer from the previous propagation. The action of each lens (or magnifier) must then be considered by further layers, in order to display the image to its real size.

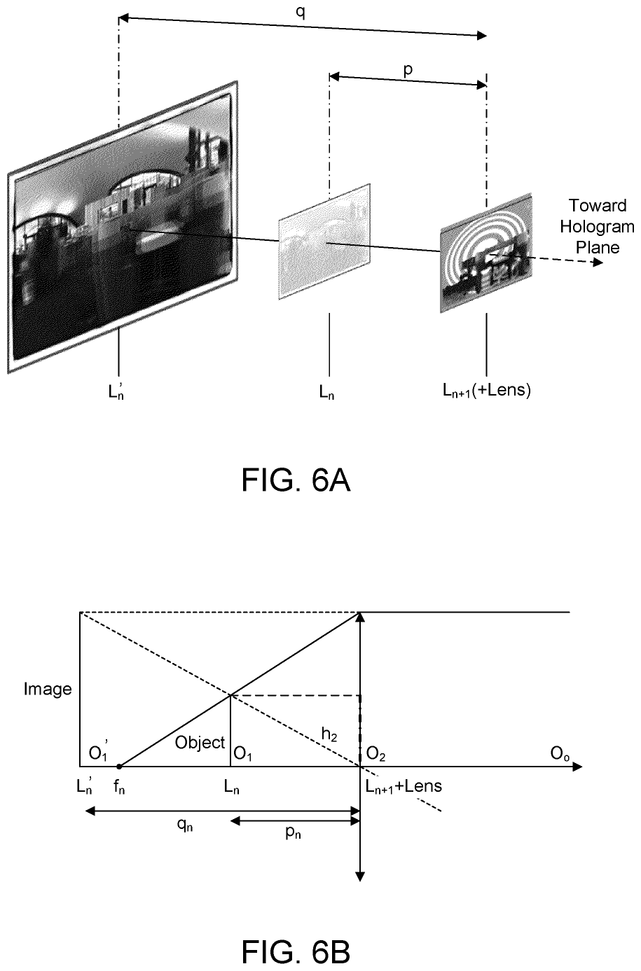

An example illustrating the magnifying process with two layers is shown in FIG. 6 that includes FIGS. 6A and 6B. In FIG. 6, Ln′ is the image of Ln (nth layer starting from the back) by the FZP, Ln+1 is the following layer on the path till the hologram plane. That is, Ln is the nth layer and is also the “object” for the Ln+1 layer. Thus, the example illustrated in FIG. 6 represents the image formation from lens and object where fₙ is the focal point of the lens.

In general, at least one example of an embodiment involves perspective projection images (such as MPIs) to reconstruct the field of view of a 3D scene while using a layer-based approach (e.g., a method, device or system) in accordance with the present disclosure. For example, at least one embodiment can involve constant resolution perspective projection images, e.g., images of fixed pixel size, associated with phase increment distribution, e.g., FZP, determined to retrieve a truncated pyramid shape of the original scene Field of View (FOV). At least one example of an embodiment can involve a layer-based approach and non-orthographic (perspective) projection images (such as MPIs), and Fresnel Zone Plates to create images of the layered scene which will have their correct dimension in the object space. In general, at least one embodiment can involve accounting for, or incorporating, adjusting or compensating for, occlusions based on information embedded in an image format such as MPIs providing a layered representation of the scene that can be used directly for layer-based method propagation with no further transformation.

The following provides additional details of various examples of embodiments. Throughout the present disclosure including the following description, terminology such as “lens”, “zone plate” (or ZP), “Fresnel zone plate” (or FZP), “magnifier”, and “phase increment distribution” will be used and are intended to encompass various features, approaches or embodiments as will be evident from the context of the present disclosure. Also, reference to MPI in the following is intended to encompass various approaches based on constant resolution perspective projection images of which MPI is an example. For ease of explanation, the following might describe one or more examples of embodiments by referring to FZP and MPI. However, such description is not intended to be, and is not limiting, as it will be readily apparent that the described features, embodiments and arrangements are applicable to approaches other than FZP and MPI. Also in the following, an image layer can be considered to be a slice of a 3D scene to be reconstructed (i.e., will be seen by a user at a certain depth). An object layer can be considered to be a slice of the 3D object scene used to compute the hologram. For example, an object layer can be one of the MPIs.

At least one example of an embodiment involves determining phase increment distributions, e.g., FZP, associated with each layer as explained in more detail below. That is, at least one example of an embodiment involves association of the layered scene with zone plates that will form images reconstructing the field of view. Each layer is magnified by a zone plate to recover its physical size in the object space. To save space and computation time, zone plates are chosen to be situated in the same place as the preceding or prior layer in line toward the hologram plane. The computation of the Fresnel zone plate only requires knowing its focal length at an associated wavelength and can be determined based on available information as follows.

First the transverse power of the entire optical system (composed of the final array of magnifiers) is computed or determined for each layer. This represents the magnifying power required by the object layer to attain its final size in the object space. This magnifying power will be referred to herein as the system transverse power of the layer n and note it γ_{sys,n}.

$${γ}_{sys , n} = \frac{{h}_{n , I}}{{h}_{n , o}}$$

where h_{n,I} is the height of the targeted image layer n, and h_{n,o} is the height of the object layer n. As the entire system is composed of N lenses (N being the number of layers), and given that the n^{th} lens will also magnify the further layers (n+1, n+2 etc.), this transverse power does not correspond to the magnification of each lens, but to the magnification of the whole system for a given image.

The magnification of each lens still needs to be computed or determined. The magnifying power of each lens will be referred to herein as the individual transverse power, note it γₙ, where n is the number associated to the object layer magnified by the lens. Thus, γₙ can be defined as:

$${γ}_{n} = \frac{{γ}_{sys , n}}{{γ}_{sys , n - 1}}$$

That is, the individual transverse power is thus defined recursively (typically in a for loop), starting from the closest layer to the hologram plane, for which γ_{sys,n}=γ₁.

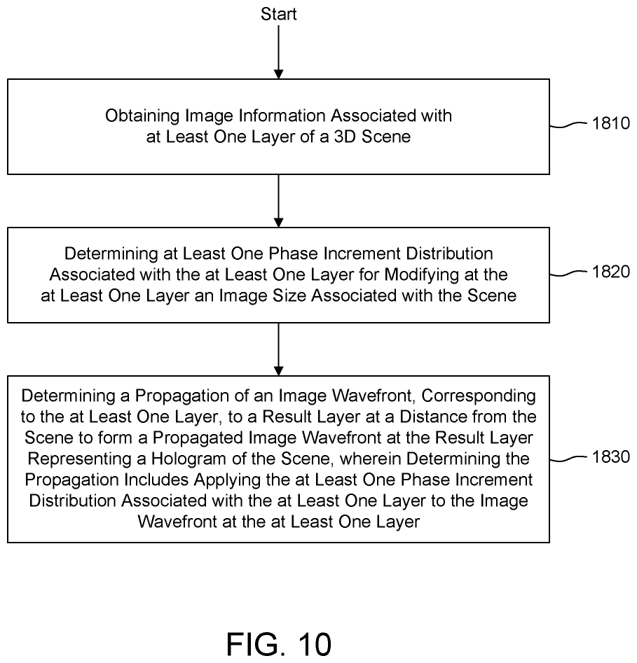

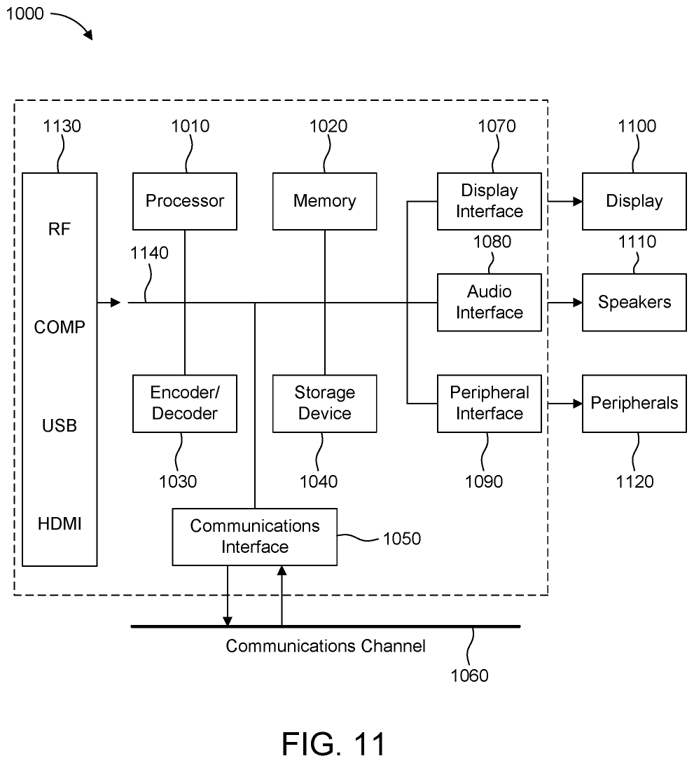

Once the transverse power of each magnifier is known, the distance from the object layer (MPI) to the lens (i.e., to the previous layer) can be computed or determined. The distances from the image and object layers to the lens, respectively noted qₙ and pₙ, are illustrated in FIGS. 10A and 10B and defined as:

$${γ}_{n} = \frac{{q}_{n}}{{p}_{n}}$$

The distance from the image to the lens is determined by the depth of the image that is to be created (matching the distance of the layer in the MPI metadata), and the position of the lens. If dₙ′ is the depth of the n^{th} image layer, and dₙ the distance of the n^{th} object layer to the hologram plane, then:

qₙ=d′−dₙ₋₁

Knowing γₗ, it is thus possible to compute p using the precedent equation linking the transverse power and image and object distances. This can be done recursively using the following equation:

$${p}_{n} = \frac{{d}_{n}^{′} - {d}_{n - 1}}{{γ}_{n}}$$

The back focal distance pₙ known, the focal distance of the zone plate is obtained from the equation:

$$\frac{1}{{f}_{n}} = \frac{1}{{q}_{n}} - \frac{1}{{p}_{n}}$$

which is the standard equation of a thin lens. With the focal length, the phase shift of the zone plate can be computed, using:

$${φ}_{F Z P , n} ( x , y ) = exp ( - \frac{2 j π}{λ} \frac{( {x}^{2} + {y}^{2} )}{2 {f}_{n}} )$$

Once this done the distance from the object layers to the hologram plane can be computed recursively (e.g., “for” loop) using:

dₙ=dₙ₋₁+pₙ

and the image layer distance to the hologram plane is then:

d′ₙ=(dₙ−dₙ₋₁)×γₙ

which should correspond to the depth of the original MPI layers.

Once the one or more phase increment distributions, e.g., FZP or magnifier parameters have been computed or determined for the associated layers such as in the manner described above, a propagation process can be performed as explained in detail below.

At least one example of an embodiment involves a propagation of an image wave front associated with image information of a layer. For example, at least one example of an embodiment involves determining a propagation of an image wave front associated with image information of at least one layer of a 3D scene to a result layer, e.g., a hologram layer, at a distance from the 3D scene. At least one other example of an embodiment involves a propagation of a plurality of image wave fronts associated with respective ones of a plurality of layers of the 3D scene to the result layer. At least one example of an embodiment involves the at least one layer including a plurality of layers, e.g., at least first and second layers, and propagation of wave fronts from these layers to the result layer. At least one example of an embodiment involves a first layer corresponding to a background layer, e.g., layer farthest from the result or hologram layer, and the second layer corresponding to at least one intermediate layer between the first layer (e.g., background layer) and the result layer.

The propagation process can occur in various ways. In general, at least one example of an embodiment can involve propagation from the at least one layer of the 3D scene, e.g., a plurality of layers, directly to the result layer, e.g., hologram plane. As explained in greater detail below, propagation according to at least one example of an embodiment can be expressed as:

Holoₚ(xᵢ,yₖ,z)=Holoₚ(xᵢ,yₖ,z)+a_{i,k}*Uₚ₁(xᵢ,yₖ,z)

where Holoₚ(xᵢ, yₖ, zₚ) is the computed hologram, Uₚₙ(xᵢ, yₖ, zₚ) is the result of the propagation of layer n to the hologram plane and a_{i,k} is the non-binary probability of the pixel (xᵢ, yₖ) of the layer n.

In general, at least one other example of an embodiment can involve propagation from a first layer furthest from the result layer, e.g., the background layer, through each additional layer of the 3D scene between the first layer and the result layer, e.g., one or more intermediate layers. The effect of the wave front passing through each layer is determined such that, in effect, the contribution to the propagated wave front at the result layer, e.g., hologram layer or hologram plane, of each layer of the 3D scene is combined or accumulated at each layer sequentially. This propagation based on sequential accumulation or combination of wave front contributions of each layer, i.e., where each layer is propagated to the next layer toward the hologram plane according to the present example of an embodiment can be expressed as:

Uₙ₊₁(xᵢ,yₖ,zₙ₊₁))=α*RGBₙ₊₁(ξₙ₊₁,ηₙ₊₁,zₙ₊₁)+Uₙ₊₁(xᵢ,yₖ,(zₙ−zₙ₊₁))

where Uₙ₊₁(xᵢ, yₖ, (zₙ−zₙ₊₁)) is the value at the layer n+1 for the pixel (xᵢ, yₖ) corresponding to the propagation of the layer n to the layer n+1. Uₙ₊₁(xᵢ, yₖ, zₙ₊₁)) is the value at the layer n+1 for the pixel (xᵢ, yₖ) corresponding to the sum of the propagation of the layer n to the layer n+1 and the current RGB value of the layer.

It should be noted that although one or more examples of embodiments described herein might be described based on layers involving perspective projection, such descriptions are not intended to be limiting. That is, one or more aspects, embodiments or features in accordance with the present disclosure involving layers of a 3D scene can apply to orthographic projection or perspective projection. Thus, the term “layer” as used herein broadly encompasses more than perspective projection.

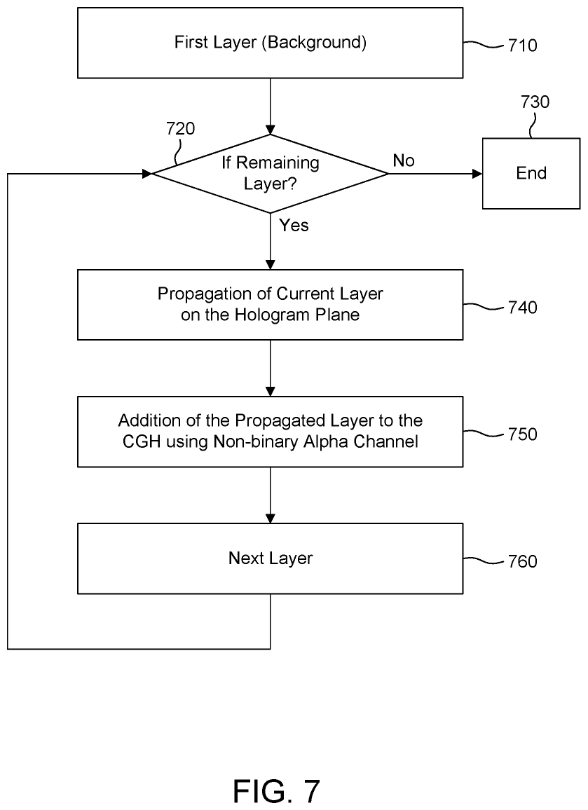

The example of an embodiment described above will now be described in more detail with reference to FIG. 7. In FIG. 7, operation begins at 710 with a first layer, e.g., a background layer, that is furthest from the result layer, e.g., the hologram layer or plane. At 720, the status of remaining layers is checked. That is, a check at 720 determines if there are additional layers other than the first layer to be considered. If not (“NO” at 720) then operation ends at 730 in that the wave front associated with the image information of the first layer propagates directly to the result layer as explained herein. If there are additional layers (e.g., “YES” at 720) then operation continues at 740 where the propagation of a wave front associated with image information of the current layer directly to the result layer is determined. Then, at 750, the propagation of the layer to the result layer is added or combined with the propagation of other layers at the result layer to form the propagated wave front at the result layer. After 750, at 760 operation proceeds to the next layer and the check at 720 of remaining layer status. Thus, the wave front associated with the image information of each layer is propagated directly to the result layer and combined directly with the contributions of other layer. For example, the contributions from each of a plurality of layers to the result layer are each determined, e.g., for a first layer such as a background layer and one or more intermediate layers, and combined to form the result. In effect, the contribution of each layer is propagated directly to the result layer and combined at the result layer to form the propagated wave front at the result layer.

In more detail, in the present example of an embodiment, each layer n is propagated individually from its zₙ position to the hologram plane zₚ. Contribution of each layer is added on the final CGH using the non-binary alpha value. The propagation of a layer n at z=zₙ to the hologram plane z=zₚ can be determined, for example, using the angular spectrum propagation of plane waves model. This model is following the equation above where the wave field Uₚ(x, y, z=zₚ) received in the hologram plane from each point Pₙ(ξ, η, zₙ) of layer n is determined by:

Uₚ(x,y,zₚ)= [symbol] {H(f_{X},f_{Y},(zₚ−zₙ)× [symbol] (Uₙ(ξ,η,zₙ))}

with:

$$H ( {f}_{X} , {f}_{Y} , z ) = \{ \frac{{e}^{j k z}}{jk λ} exp [ j \frac{π}{λ z} ( {x}^{2} + {y}^{2} ) ] \} or$$

$$H ( {f}_{X} , {f}_{Y} , z ) = {e}^{j k z} exp [ - j πλ z ( {f}_{X}^{2} + {f}_{Y}^{2} ) ]$$

where k=2π/λ is the wave factor, (x, y) are the coordinate of space in hologram plane, (ι, η) are the coordinate in layer n plane, (zₚ−zₙ) is the distance between layer n and the hologram plane, and Uₙ(ξ, η, zₙ) is the light field emitted by the layer image within its plane. [symbol] and [symbol] are respectively the Fourier Transform and Inverse Fourier Transform. Reference to the Fast Fourier Transform (FFT) and Inverse Fast Fourier Transform (IFFT) is only an example. More generally, a diffractive Fourier transform can be applied.

As the layer images are pixelated, wave fields are expressed in discrete manner, Uₙ(x, y, zₙ) becomes Uₙ(xᵢ, yₖ, zₙ), where [i, k] are integers respectively corresponding to the horizontal and vertical indices of the image pixels. The z coordinate remains a continuous coordinate. Once done, the wavefield emitted by the layer n to the hologram plane is determined by the following equation:

Uₚ(xᵢ,yₖ,zₚ)=IFFT{H(f_{X},f_{Y},(zₚ−zₙ))×FFT(Uₙ(ξₙ,ηₙ,zₙ))}

At least one example of an embodiment involves considering RGB values for each pixel as being associated with a non-binary α information. This α information represents a probability for the pixel to be effectively at this depth. For example, the α information can represent occlusion information. This α is then integrated in the calculation at the hologram plane following the equation:

Uₚ(xᵢ,yₖ,zₚ,a_{i,k})=IFFT{H(f_{X},f_{Y},(zₚ−zₙ))×FFT(a_{i,k}*Uₙ(ξₙ,ηₙ,zₙ))}

where Uₚ(xᵢ, yₖ, zₚ, a_{i,k}) is the result of the propagation of layer n to the hologram plane and a_{i,k} is the non-binary probability of the pixel (xᵢ, yₖ) of the layer n.

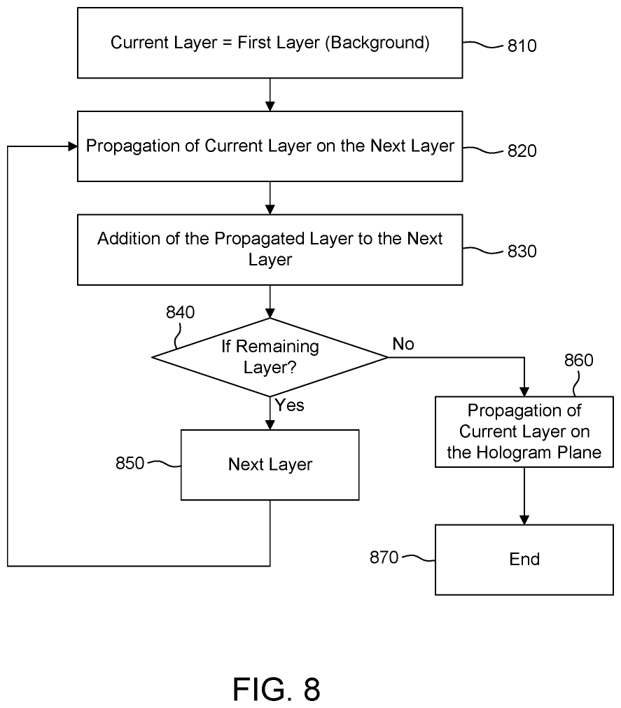

The example of an embodiment described above will now be described with reference to FIG. 8. In FIG. 8, operation begins at 810 with a first layer, e.g., a background layer, that is furthest from the result layer, e.g., the hologram layer or plane. At 820, the propagation of the current layer to the next layer is determined. For example, the propagation from the first layer, e.g., the background layer, to a second layer, e.g., an intermediate layer between the first layer and the result layer, is determined. At 830, the propagation to the next layer is combined with, e.g., added to, the next layer. At 840, the status of remaining layers is checked. That is, a check at 840 determines if there are additional layers to be considered. If not (“NO” at 840) then propagation of the current layer, e.g., combination of propagation of the first layer with the second layer, to the result layer is determined at 860 to provide the propagated wave front at the result layer and operation ends at 870. If there are additional layers (e.g., “YES” at 840) then operation continues at 850 where the next layer, e.g., another intermediate layer, is selected followed by repetition of 820 for propagation of the current layer to the next layer. Thus, operation at 820 through 850 repeat until all layers are considered to sequentially propagate the wave front from each layer to the next until the resulting wave front from the last layer propagates to the result layer to provide the propagated wave front at the result layer.

In more detail, an example of an embodiment described above involves propagation layer by layer as follows. The propagation process starts with considering a first layer, e.g., the background layer, that is the layer furthest from the hologram plane. This first layer, referred to herein as layer 1, is considered as a light source. Its propagation can be determined by applying a diffraction model, e.g., an angular spectrum model or a Fresnel diffraction, to the corresponding image information of the layer, e.g., RGBA image data. The diffraction model, e.g., angular spectrum model, enables determining the optical field propagation and provides for, or enables, determining the optical field received at a plane in space from a source plane. The wave field U₂(x, y, z) received in P₂(x, y, z) from each point P₁(ξ, η, 0) of layer 1 is determined by:

U₁(x,y,z)= [symbol] {H(f_{X},f_{Y},z)× [symbol] (U₁(ξ,η,0))}

with:

$$H ( {f}_{X} , {f}_{Y} , z ) = \{ \frac{{e}^{j k z}}{j k λ} exp [ j \frac{π}{λ z} ( {x}^{2} + {y}^{2} ) ] \} or$$

$$H ( {f}_{X} , {f}_{Y} , z ) = {e}^{j k z} exp [ - j πλ z ( {f}_{X}^{2} + {f}_{Y}^{2} ) ]$$

where k=2π/λ is the wave factor, (x, y) are the coordinate of space in layer 2 plane, (ξ, η) are the coordinate in layer 1 plane and z is the distance between layer 1 and layer 2.

In practice, determining the propagation can be based on a diffractive Fourier transform, e.g., a Fast Fourier Transform (FFT) and/or Inverse Fast Fourier Transform (IFFT). The image information associated with a layer can be, for example, RGBA image information represents pixelated image information because the RGBA image is actually three matrices of pixels: R, G, B+a matrix of pixel Alpha. As a result of being pixelated, wave fields are expressed in discrete manner, U₁(x, y, z) becomes U₁(xᵢ, yₖ, z), where [i, k] are integers respectively corresponding to the horizontal and vertical indices of the image pixels. The z coordinate remains a continuous coordinate. Once done, the wavefield emitted by the layer 2 is determined by the following equation:

U₂(xᵢ,yₖ,z)=U₁(xᵢ,yₖ,z)+RGBA(xᵢ,yₖ,z)×α

Where RGBA(xᵢ, yₖ, z) is the contribution of the layer 2 to the wave field, meaning the emission level of each pixel (i, k) of the image, and U₂(xᵢ, yₖ, z) is the optical field in (xᵢ, yₖ, z) point of space. Thus, the sum can be performed pixel by pixel.

By applying the phase increment distribution, the previous equation becomes:

U₂(xᵢ,yₖ,z)=U₁(xᵢ,yₖ,z)×φ_{PFZP,n}(x,y)+RGBA(xᵢ,yₖ,z)×α

The phase increment distribution is thus applied to the propagating field U₁(xᵢ, yₖ, z), falling on the next layer in line (here layer 2). The same principle can be used, starting from U₂(xᵢ, yₖ, z), over and over, i.e., repeatedly or iteratively for each layer, until the hologram plane is reached. When the hologram plane is reached, the hologram can be formed from the propagated wave obtained by this process, and a given (arbitrary) reference wave.

The process used to propagate from layer 1 to layer 2 can then be applied to propagate to the next layer.

In general, an example of a variant of can involve each layer n being propagated to the next layer n+1 toward the hologram plane, wherein the propagated layer is added to the next layer using a non-binary alpha value. Then the addition of the two terms is itself propagated to the next layer n+2 and so on up to the last layer. Then the last layer after the addition of the previous layer contribution is propagated to the hologram plane.

The propagation of a layer n to the layer n+1 can be determined, for example, using the angular spectrum propagation of plane waves model as explained above.

As the layer images are pixelated, wave fields are expressed in discrete manner, Uₙ(x, y, zₙ) becomes Uₙ(xᵢ, yₖ, zₙ), where [i, k] are integers respectively corresponding to the horizontal and vertical indices of the image pixels. The z coordinate remains a continuous coordinate. Once done, the wavefield emitted by the layer n to the layer n+1 is determined by the following equation:

Uₙ₊₁(xᵢ,yₖ,(zₙ−zₙ₊₁))=IFFT{H(f_{X},f_{Y},(zₙ−zₙ₊₁))×FFT(Uₙ(ξₙ,ηₙ,zₙ))}

In the present variant, RGB values for each pixel are considered to be associated with a non-binary α information. This α information represents a probability for the pixel to be effectively at this depth, i.e., probability of belonging to a layer. This α is then integrated in the calculation of the first term at layer 0 and at each layer n+1 as follows:

U₀(ξ₀,η₀,z₀)=α*RGB₀(ξ₀,η₀,z₀)

Uₙ₊₁(xᵢ,yₖ,zₙ₊₁))=α*RGBₙ₊₁(ξₙ₊₁,ηₙ₊₁,zₙ₊₁)+Uₙ₊₁(xᵢ,yₖ,(zₙ−zₙ₊₁)) (1)

where Uₙ₊₁(xᵢ, yₖ, (zₙ−zₙ₊₁)) is the value at the layer n+1 for the pixel (xᵢ, yₖ) corresponding to the propagation of the layer n to the layer n+1. Uₙ₊₁(xᵢ, yₖ, zₙ₊₁)) is the value at the layer n+1 for the pixel (xᵢ, yₖ) corresponding to the sum of the propagation of the layer n to the layer n+1 and the current RGB value of the layer.
When the last layer is reached, there is a last propagation applied to the sum of all layers to the distance of the hologram plane.

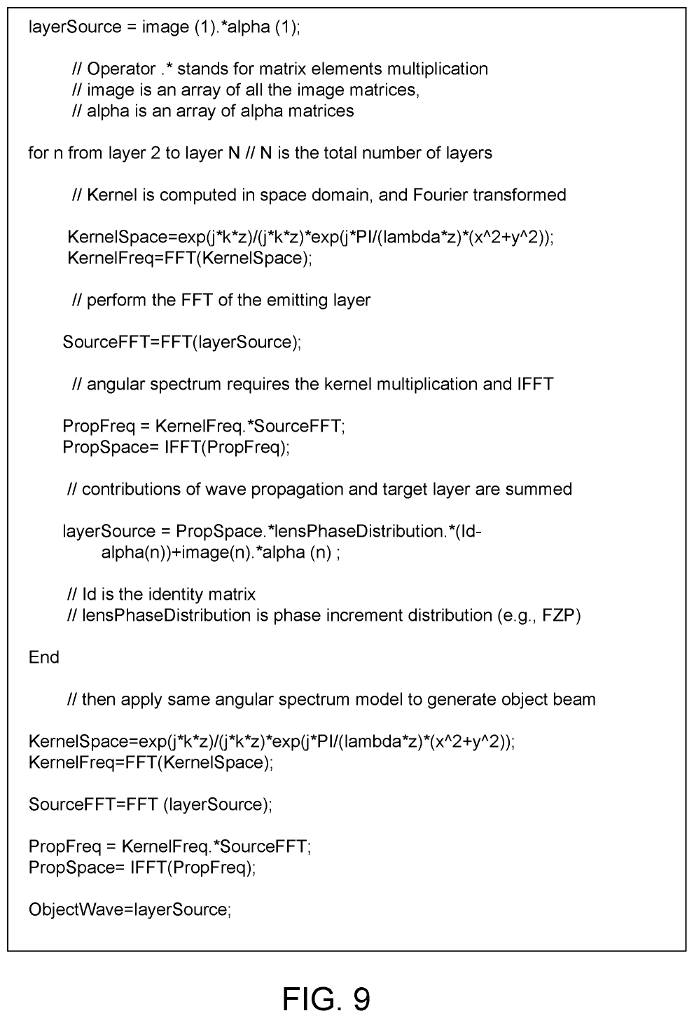

In general, another example of an embodiment can involve an embodiment such as that described above with regard to FIG. 8 implemented in executable program code stored, e.g., in a computer program product such as a non-transitory computer-readable medium that, when executed by a computer, e.g., comprising one or more processors, performs one or more examples of methods as described herein. An example of embodiment of such executable program code is provided by the pseudo code shown in FIG. 9.

This document describes various examples of embodiments, features, models, approaches, etc. Many such examples are described with specificity and, at least to show the individual characteristics, are often described in a manner that may appear limiting. However, this is for purposes of clarity in description, and does not limit the application or scope. Indeed, the various examples of embodiments, features, etc., described herein can be combined and interchanged in various ways to provide further examples of embodiments.

In general, the examples of embodiments described and contemplated in this document can be implemented in many different forms. For example, FIG. 10 described below provides an embodiment, but other embodiments are contemplated and the discussion of FIG. 10 does not limit the breadth of the implementations. This and other embodiments can be implemented as a method, an apparatus, a system, a computer readable storage medium or non-transitory computer readable storage medium having stored thereon instructions for implementing one or more of the examples of methods described herein.

Various methods are described herein, and each of the methods comprises one or more steps or actions for achieving the described method. Unless a specific order of steps or actions is required for proper operation of the method, the order and/or use of specific steps and/or actions may be modified or combined.

Various embodiments, e.g., methods, and other aspects described in this document can be used to modify a system such as the example shown in FIG. 10 that is described in detail below. For example, one or more devices, features, modules, etc. of the example of FIG. 10, and/or the arrangement of devices, features, modules, etc. of the system (e.g., architecture of the system) can be modified. Unless indicated otherwise, or technically precluded, the aspects, embodiments, etc. described in this document can be used individually or in combination.

Various numeric values are used in the present document, for example. The specific values are for example purposes and the aspects described are not limited to these specific values.

FIG. 10 illustrates a block diagram of an example of a system in which various aspects and embodiments can be implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 can include an encoder/decoder module 1030 configured, for example, to process image data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream or signal, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during operations such as those described herein. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010. Similarly, aspects of USB or HDMI interface processing can be implemented within separate interface ICs or within processor 1010. The demodulated, error corrected, and demultiplexed stream is provided to various processing elements, including, for example, processor 1010, and encoder/decoder 1030 operating in combination with the memory and storage elements to process the datastream for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the I2C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AV.Link, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device, for example, a television. In various embodiments, the display interface 1070 includes a display driver, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various generalized as well as particularized embodiments are also supported and contemplated throughout this disclosure. Examples of embodiments in accordance with the present disclosure include but are not limited to the following.

In general, at least one example of an embodiment can involve a method comprising: obtaining image data associated with at least one layer of a 3D scene; determining at least one phase increment distribution associated with the at least one layer for modifying at the at least one layer an image size associated with the scene; and determining a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.

In general, at least one other example of an embodiment can involve apparatus comprising: at least one processor configured to obtain image data associated with at least one layer of a 3D scene; determine at least one phase increment distribution associated with the at least one layer for modifying at the least one layer an image size associated with the scene; and determine a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.

In general, at least one other example of an embodiment can involve a method or apparatus including obtaining at least one layer of a 3D scene, wherein the at least one layer comprises a plurality of layers of the 3D scene that includes a first layer at a first distance from the result layer and at least one second layer between the first layer and the result layer.

In general, at least one other example of an embodiment can involve a method or apparatus including determining at least one phase increment, wherein the determining comprises determining a plurality of phase increment distributions, and each of the plurality of phase increment distributions is associated with one of a plurality of layers of a 3D scene for modifying the image size at the associated one of the plurality of layers.

In general, at least one other example of an embodiment can involve a method or apparatus including determining a propagation of an image wave front and further comprising determining propagation of the image wave front from a first layer to at least one second layer and from the at least one second layer to a result layer, and wherein the propagation includes, for each of the first layer and the at least one second layer, applying a respective one of a plurality of phase increment distributions associated with a layer to the image wave front at the layer.

In general, at least one other example of an embodiment can involve a method or apparatus including determining, for each of a plurality of layers of a 3D scene, a propagation to a result layer of an image wave front associated with the image data of the layer based on applying a one of a plurality of phase increment distributions associated with a layer to the image data of the layer.

In general, at least one other example of an embodiment can involve a method or apparatus including determining a propagation of an image wave front to a result layer and further comprising combining the propagation of each of the plurality of image wave fronts associated with respective ones of the plurality of layers to form the propagated image wave front at the result layer representing the hologram of the scene.

In general, at least one other example of an embodiment can involve a method comprising: obtaining image data associated with a plurality of layers of a 3D scene including a first layer at a first distance from a result layer and a second layer at a second distance from the result layer, wherein the first distance is greater than the second distance; determining a plurality of phase increment distributions, wherein each of the plurality of phase increment distributions is associated with a respective one of the plurality of layers for modifying, at the respective one of the plurality of layers, an image size associated with the scene; and determining an image wave front at each of the plurality of layers based on a propagation of an image wave front from the first layer through the second layer to the result layer to form a propagated image wave front at the result layer representing a hologram of the scene, wherein the propagation includes, for each of the first layer and the second layer, applying a respective one of the plurality of phase increment distributions associated with a layer to the image wave front at the layer.

In general, at least one other example of an embodiment can involve apparatus comprising: at least one processor configured to obtain image data associated with a plurality of layers of a 3D scene including a first layer at a first distance from a result layer and a second layer at a second distance from the result layer, wherein the first distance is greater than the second distance; determine a plurality of phase increment distributions, wherein each of the plurality of phase increment distributions is associated with a respective one of the plurality of layers to modify at the respective one of the plurality of layers an image size associated with the scene; and determine an image wave front at each of the plurality of layers based on a propagation of an image wave front from the first layer through the second layer to the result layer to form a propagated image wave front representing a hologram at the result layer, wherein the propagation includes, for each of the first layer and the second layer, applying a respective one of the plurality of phase increment distributions associated with a layer to the image wave front at the layer.

In general, at least one other example of an embodiment can involve a method comprising: obtaining image data associated with a plurality of layers of a 3D scene; determining a plurality of phase increment distributions, each associated with a respective one of the plurality of layers, for modifying at the respective one of the plurality of layers an image size associated with the scene; determining, for each of the plurality of layers, a propagation to the result layer of an image wave front associated with the image data of the layer based on applying a respective one of the plurality of phase increment distributions associated with a layer to the image data of the layer; and combining the propagation of each of the plurality of image wave fronts associated with respective ones of the plurality of layers to form a propagated image wave front at the result layer representing a hologram of the scene.

In general, at least one other example of an embodiment can involve apparatus comprising: at least one processor configured to obtain image data associated with a plurality of layers of a 3D scene; determine a plurality of phase increment distributions, each associated with a respective one of the plurality of layers, for modifying at the respective one of the plurality of layers an image size associated with the scene; determine, for each of the plurality of layers, a propagation to the result layer of an image wave front associated with the image data of the layer based on applying a respective one of the plurality of phase increment distributions associated with a layer to the image data of the layer; and combine the propagation of each of the plurality of image wave fronts associated with respective ones of the plurality of layers to form a propagated image wave front at the result layer representing a hologram of the scene.

In general, at least one other example of an embodiment can involve a method or apparatus, wherein each of a plurality of layers of a 3D scene represents a corresponding one of a plurality of perspective view images at different depths in the 3D scene.

In general, at least one other example of an embodiment can involve a method or apparatus, wherein each of a plurality of perspective view images has a constant resolution.

In general, at least one other example of an embodiment can involve a method or apparatus, wherein a first layer of a 3D scene corresponds to a background layer of the 3D scene and a second layer corresponds to an intermediate layer of the 3D scene between the background layer and a result layer.

In general, at least one other example of an embodiment can involve a method or apparatus, wherein modifying an image size associated with a layer of a 3D scene comprises reconstructing a field of view associated with the scene.

In general, at least one other example of an embodiment can involve a method or apparatus, wherein determining a propagated image wave front at a result layer comprises applying to the image wave front at each layer of a plurality of layers of a 3D scene non-binary information associated with the image data of the layer, and wherein the non-binary information represents a probability of belonging to a layer.

In general, at least one other example of an embodiment can involve a method or apparatus, wherein non-binary information representing a probability of belonging to a layer represents occlusion information.

In general, at least one other example of an embodiment can involve a method or apparatus, wherein determining a propagation of an image wave front associated with image information of one or more layers of a 3D scene further comprises applying a diffraction model to the image information.

In general, at least one other example of an embodiment can involve a method or apparatus, wherein applying a diffraction model comprises applying at least one of an angular spectrum model or a Fresnel diffraction to image information.

In general, at least one other example of an embodiment can involve a method or apparatus, wherein determining a propagation of an image wave front further comprises applying a diffractive Fourier transform.

In general, at least one other example of an embodiment can involve a method or apparatus, wherein applying a diffractive Fourier transform comprises applying a fast Fourier transform and/or an inverse fast Fourier transform.

In general, at least one other example of an embodiment can involve a method or apparatus, wherein image information associated with a layer of a 3D scene comprises RGBA information.

In general, at least one other example of an embodiment can involve a method or apparatus, wherein determining a plurality of phase increment distributions comprises determining a plurality of Fresnel Zone Plates (FZP), each of the plurality of FZPs providing a phase shift corresponding to one of the plurality of phase increment distributions.

In general, at least one example of an embodiment can involve a computer program product including instructions, which, when executed by a computer, cause the computer to carry out any one or more of the methods described herein.

In general, at least one example of an embodiment can involve a non-transitory computer readable medium storing executable program instructions to cause a computer executing the instructions to perform any one or more of the methods described herein.

In general, at least one example of an embodiment can involve a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.

In general, at least one example of an embodiment can involve a device as described herein, wherein the device comprises one of a television, a television signal receiver, a set-top box, a gateway device, a mobile device, a cell phone, a tablet, a computer such as a laptop computer or a desktop computer, a server, or other electronic device.

Regarding the various embodiments described herein and the figures illustrating various embodiments, when a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, one or more of a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “obtaining” various pieces of information. Obtaining the information can include one or more of, for example, determining the information, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for refinement. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream or signal of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments have been described. Embodiments may include any of the following features or entities, alone or in any combination, across various different claim categories and types:
Providing a method comprising, or an apparatus comprising one or more processors configured for, obtaining image data associated with at least one layer of a 3D scene; determining at least one phase increment distribution associated with the at least one layer for modifying at the at least one layer an image size associated with the scene; and determining a propagation of an image wave front, corresponding to the at least one layer, to a result layer at a distance from the scene to form a propagated image wave front at the result layer representing a hologram of the scene, wherein determining the propagation includes applying the at least one phase increment distribution associated with the at least one layer to the image wave front at the at least one layer.
Providing a method comprising, or an apparatus comprising one or more processors configured for, obtaining at least one layer of a 3D scene, wherein the at least one layer comprises a plurality of layers of the 3D scene that includes a first layer at a first distance from the result layer and at least one second layer between the first layer and the result layer.
Providing a method comprising, or an apparatus comprising one or more processors configured for, determining a plurality of phase increment distributions, and each of the plurality of phase increment distributions is associated with one of a plurality of layers of a 3D scene for modifying the image size at the associated one of the plurality of layers.
Providing a method comprising, or an apparatus comprising one or more processors configured for, determining a propagation of an image wave front and further comprising determining propagation of the image wave front from a first layer to at least one second layer and from the at least one second layer to a result layer, and wherein the propagation includes, for each of the first layer and the at least one second layer, applying a respective one of a plurality of phase increment distributions associated with a layer to the image wave front at the layer.
Providing a method comprising, or an apparatus comprising one or more processors configured for, determining, for each of a plurality of layers of a 3D scene, a propagation to a result layer of an image wave front associated with the image data of the layer based on applying a one of a plurality of phase increment distributions associated with a layer to the image data of the layer.
Providing a method comprising, or an apparatus comprising one or more processors configured for, determining a propagation of an image wave front to a result layer and further comprising combining the propagation of each of a plurality of image wave fronts associated with respective ones of the plurality of layers of a 3D scene to form a propagated image wave front at a result layer representing a hologram of the scene.
Providing a method comprising, or an apparatus comprising one or more processors configured for, obtaining image data associated with a plurality of layers of a 3D scene including a first layer at a first distance from a result layer and a second layer at a second distance from the result layer, wherein the first distance is greater than the second distance; determining a plurality of phase increment distributions, wherein each of the plurality of phase increment distributions is associated with a respective one of the plurality of layers for modifying, at the respective one of the plurality of layers, an image size associated with the scene; and determining an image wave front at each of the plurality of layers based on a propagation of an image wave front from the first layer through the second layer to the result layer to form a propagated image wave front at the result layer representing a hologram of the scene, wherein the propagation includes, for each of the first layer and the second layer, applying a respective one of the plurality of phase increment distributions associated with a layer to the image wave front at the layer.
Providing a method comprising, or an apparatus comprising one or more processors configured for, obtaining image data associated with a plurality of layers of a 3D scene; determining a plurality of phase increment distributions, each associated with a respective one of the plurality of layers, for modifying at the respective one of the plurality of layers an image size associated with the scene; determining, for each of the plurality of layers, a propagation to the result layer of an image wave front associated with the image data of the layer based on applying a respective one of the plurality of phase increment distributions associated with a layer to the image data of the layer; and combining the propagation of each of the plurality of image wave fronts associated with respective ones of the plurality of layers to form a propagated image wave front at the result layer representing a hologram of the scene.
Providing a method comprising, or an apparatus comprising one or more processors configured for, processing a plurality of layers of a 3D scene, each of the plurality of layers representing a corresponding one of a plurality of perspective view images at different depths in the 3D scene.
Providing a method comprising, or an apparatus comprising one or more processors configured for, processing a plurality of perspective view images of a 3D scene corresponding to layers at different depths in the 3D scene, wherein the plurality of perspective view images has a constant resolution.
Providing a method comprising, or an apparatus comprising one or more processors configured for, processing at least first and second layers of a 3D scene wherein the first layer corresponds to a background layer of the 3D scene and a second layer corresponds to an intermediate layer of the 3D scene between the background layer and a result layer.
Providing a method comprising, or an apparatus comprising one or more processors configured for, modifying an image size associated with a layer of a 3D scene, wherein the modifying comprises reconstructing a field of view associated with the scene.
Providing a method comprising, or an apparatus comprising one or more processors configured for, determining a propagated image wave front at a result layer, wherein the determining comprises applying to the image wave front at each layer of a plurality of layers of a 3D scene non-binary information associated with the image data of the layer, and wherein the non-binary information represents a probability of belonging to a layer.
Providing a method comprising, or an apparatus comprising one or more processors configured for, applying non-binary information representing a probability of belonging to a layer, wherein the probability of belonging to a layer represents occlusion information.
Providing a method comprising, or an apparatus comprising one or more processors configured for, determining a propagation of an image wave front associated with image information of one or more layers of a 3D scene further based on applying a diffraction model to the image information.
Providing a method comprising, or an apparatus comprising one or more processors configured for, applying a diffraction model based on applying at least one of an angular spectrum model or a Fresnel diffraction to image information.
Providing a method comprising, or an apparatus comprising one or more processors configured for, determining a propagation of an image wave front based on applying a diffractive Fourier transform.
Providing a method comprising, or an apparatus comprising one or more processors configured for, determining a propagation of an image wave front based on applying a diffractive Fourier transform involving applying a fast Fourier transform and/or an inverse fast Fourier transform.
Providing a method comprising, or an apparatus comprising one or more processors configured for, processing image information associated with a layer of a 3D scene wherein the image information comprises RGBA information.
Providing a method comprising, or an apparatus comprising one or more processors configured for, determining a plurality of phase increment distributions based on determining a plurality of Fresnel Zone Plates (FZP), each of the plurality of FZPs providing a phase shift corresponding to one of the plurality of phase increment distributions.
Providing a computer program product including instructions, which, when executed by a computer, cause the computer to carry out any one or more of the methods described herein.
Providing a non-transitory computer readable medium storing executable program instructions to cause a computer executing the instructions to perform any one or more of the methods described herein.
Providing a device comprising an apparatus according to any embodiment of apparatus as described herein, and at least one of (i) an antenna configured to receive a signal, the signal including data representative of information such as instructions from an orchestrator, (ii) a band limiter configured to limit the received signal to a band of frequencies that includes the data representative of the information, and (iii) a display configured to display an image such as a displayed representation of the data representative of the instructions.
Providing a device as described herein, wherein the device comprises one of a television, a television signal receiver, a set-top box, a gateway device, a mobile device, a cell phone, a tablet, a server or other electronic device.

Various other generalized, as well as particularized embodiments are also supported and contemplated throughout this disclosure.

What is claimed is:

1-27. (canceled)

28. A method comprising:
obtaining image data associated with a plurality of layers of a 3D scene including a first layer at a first distance from a result layer and a second layer at a second distance from the result layer, wherein the first distance is greater than the second distance;
determining a plurality of phase increment distributions, wherein each of the plurality of phase increment distributions is associated with a respective one of the plurality of layers for modifying, at the respective one of the plurality of layers, an image size associated with the scene; and
determining an image wave front at each of the plurality of layers based on a propagation of an image wave front from the first layer through the second layer to the result layer to form a propagated image wave front at the result layer representing a hologram of the scene, wherein the propagation includes, for each of the first layer and the second layer, applying a respective one of the plurality of phase increment distributions associated with a layer to the image wave front at the layer.

29. The method of claim 28, wherein each of the plurality of layers represents a corresponding one of a plurality of perspective view images at different depths in the 3D scene.

30. The method of claim 28, wherein each of the plurality of perspective view images has a constant resolution.

31. The method of claim 28, wherein the first layer corresponds to a background layer of the 3D scene and the second layer corresponds to an intermediate layer of the 3D scene between the background layer and the result layer.

32. The method of claim 28, further comprising adapting image information corresponding to the propagated image wave front at the result layer to represent a hologram of the scene.

33. The method of claim 28, further comprising combining the propagation of each of the plurality of image wave fronts associated with respective ones of the plurality of layers to form a propagated image wave front at the result layer representing a hologram of the scene.

34. The method of claim 28, further comprising restructuring a field of view associated with the scene to modify the image size.

35. The method of claim 28, further comprising applying to the image wave front at each layer non-binary information associated with the image data of a layer to determine the propagation to form the propagated image wave front at the result layer.

36. The method of claim 28, further comprising applying at least one of an angular spectrum model or a Fresnel diffraction to the image information to determine the propagation.

37. The method of claim 28, method further comprising determining a plurality of Fresnel Zone Plates (FZP), each of the plurality of FZPs providing a phase shift corresponding to one of the plurality of phase increment distributions, to determine the plurality of phase increment distributions.

38. A wireless transmit receive unit (WTRU) comprising:
a memory; and
a processor configured to:
obtain image data associated with a plurality of layers of a 3D scene including a first layer at a first distance from a result layer and a second layer at a second distance from the result layer, wherein the first distance is greater than the second distance;
determine a plurality of phase increment distributions, wherein each of the plurality of phase increment distributions is associated with a respective one of the plurality of layers for modifying, at the respective one of the plurality of layers, an image size associated with the scene; and
determine an image wave front at each of the plurality of layers based on a propagation of an image wave front from the first layer through the second layer to the result layer to form a propagated image wave front at the result layer representing a hologram of the scene, wherein the propagation includes, for each of the first layer and the second layer, applying a respective one of the plurality of phase increment distributions associated with a layer to the image wave front at the layer.

39. The WTRU of claim 38, wherein each of the plurality of layers represents a corresponding one of a plurality of perspective view images at different depths in the 3D scene.

40. The WTRU of claim 38, wherein each of the plurality of perspective view images has a constant resolution.

41. The WTRU of claim 38, wherein the first layer corresponds to a background layer of the 3D scene and the second layer corresponds to an intermediate layer of the 3D scene between the background layer and the result layer.

42. The WTRU of claim 38, wherein the processor is further configured to adapt image information corresponding to the propagated image wave front at the result layer to represent a hologram of the scene.

43. The WTRU of claim 38, wherein the processor is further configured to combine the propagation of each of the plurality of image wave fronts associated with respective ones of the plurality of layers to form a propagated image wave front at the result layer representing a hologram of the scene.

44. The WTRU of claim 38, wherein the processor is further configured to restructure a field of view associated with the scene to modify the image size.

45. The WTRU of claim 38, wherein the processor is further configured to apply to the image wave front at each layer non-binary information associated with the image data of a layer to determine the propagation to form the propagated image wave front at the result layer.

46. The WTRU of claim 38, wherein the processor is further configured to apply at least one of an angular spectrum model or a Fresnel diffraction to the image information to determine the propagation.

47. The WTRU of claim 38, wherein the processor is further configured to determine a plurality of Fresnel Zone Plates (FZP), each of the plurality of FZPs providing a phase shift corresponding to one of the plurality of phase increment distributions, to determine the plurality of phase increment distributions.
